(19) United States
(12) Patent Application Publication
(10) Pub. No.: US 2011/0225770 A1
(43) Pub. Date: Sep. 22, 2011

(54) Escutcheon Configuration for a Door

(76) Inventor: Helmut Alber, Schlanders (BZ) (IT)

(21) Appl. No.: 13/030,474

(22) Filed: Feb. 18, 2011

(30) Foreign Application Priority Data
Mar. 19, 2010 (DE) 10 2010 012 220.3

(51) Int. Cl. E06B 7/28; B23P 11/00

(52) U.S. Cl. 16/402; 29/428

(57) ABSTRACT

An escutcheon assembly for a door having two escutcheon members which may be applied to opposite sides of the door and can be attached to each other by at least one attachment system. The attachment system includes at least one first attachment member and at least one second attachment member, wherein the at least one first attachment member is located on the back of one of the escutcheon members and the at least one second attachment member is located on the back of the other escutcheon member, and wherein the at least one first attachment member can be firmly attached to the at least one second attachment member. The at least one second attachment member features an accommodating element into which the at least one first attachment member can be inserted. The accommodating element is reversibly deformable such that through the insertion of the at least one first attachment member, the at least one first attachment member can be firmly anchored in the accommodation element.

This patent application claims priority to German Patent Application No. DE 10 2010 012 220.3, filed on Mar. 19, 2010, which is entitled “Escutcheon Configuration for a Door,” which is assigned to the assignee of the present application, and which patent application is hereby incorporated herein by reference in its entirety.

### BACKGROUND OF THE INVENTION

### Field of the Invention

The present invention relates generally to escutcheons for doors and more particularly to a escutcheon assembly for a door which, when installed directly onto a door, will have no visible mounting hardware.

In the field of architectural hardware, a distinction is made between door handle escutcheons and keyhole escutcheons. While door handle escutcheons are typically used for upper level applications, keyhole escutcheons are typically located on the ground floors to encase the keyholes. The attachment of a keyhole escutcheon to a door is normally achieved using screws. However, these screws remain visible, which may be found to be aesthetically displeasing.

To deal with this there are, for example, the so-called “clip escutcheons,” examples of which are found in German Utility Model No. DE 1 971 389 U1 and European Patent Application No. EP 0 484 594 A1, to Engel. With such devices, an escutcheon housing is first attached to the door by means of screws. In order to mask the screws, a separate cover plate is subsequently attached to the housing. This may be accomplished by means of springs and locking elements. In this manner, although the screws are no longer visible, the escutcheon assumes a significant thickness. This approach too is often found to be visually unappealing. Furthermore, there is the danger of the masking element loosening from the housing over the course of time, resulting in the screws again becoming visible.

A further disadvantage with this solution is the complicated mounting of the escutcheons. For this, the attachment screws must be of an appropriate length for the respective thickness of the door. If they are too short or too long, the escutcheon cannot be installed. As a result, it is usually necessary to provide a variety of screws. The installation also requires the appropriate tools for tightening the screws. Furthermore, at least five installation steps are required on each side of the door: first, holes must be drilled in the door to accommodate the screws; then the respective housing must be applied; next, the screws must be inserted through the housing into the holes; subsequently, the screws must be tightened; and finally, the masking plate must be applied. Accordingly, this installation process is labor intensive and requires an undue amount of time.

It may thus be appreciated that it would be advantageous to eliminate this and further disadvantages of the prior art and to produce an escutcheon for a door, in particular for the keyhole, which can be produced economically using readily available components and which is easy to install. In particular, it would be desirable to construct the escutcheon in such a manner that it is as thin as possible, and so that it can be installed without tools. The necessary attachment elements of such an escutcheon should not be visible after the installation. Furthermore, the installment should be possible irrespective of the thickness of the door and should ensure that a durable and proper installation is obtained.

### SUMMARY OF THE INVENTION

The main characteristics of the invention are given in the independent claims. Embodiments of the invention are given in the dependent claims.

The present invention provides an escutcheon assembly for a door, wherein the escutcheon assembly includes two escutcheon members which may be attached to opposite sides of a door. Using an attachment system, the two escutcheon members may be attached to each other, with the attachment system comprising at least one first attachment member and at least one second attachment member, The at least one first attachment member is located on the back surface of one of the escutcheon members and the at least one second attachment member is located on the back surface of the other escutcheon member, such that the at least one attachment member can be inserted into the at least one second attachment member, The at least one second attachment element features an accommodating element into which the at least one first attachment member may be inserted, with the accommodating element being reversibly deformable such that when the at least one first attachment member is inserted into the accommodating element it can form a firm attachment.

Because the attachment members are located on the back sides of the escutcheon members and are as such significant parts of the escutcheon members, the escutcheon members can be attached to each other directly. The purpose of this is that when the attachment members are structured in this manner, the first attachment member can be inserted into the second attachment member. For this, the second attachment member may feature an axial hole or a sleeve for accommodating the first attachment member. The first attachment member may take the form of a shaft, for example, which is inserted into the sleeve or axial hole and is held therein by friction.

The invention thereby provides the significant advantage that in the escutcheon members neither additional, externally visible, holes for other attachment elements nor additional masking elements of any form are necessary. Consequently, the entire escutcheon assembly may be constructed such that is it particularly thin and visually appealing.

A particular advantage of the invention consists of the fact that the accommodating element is reversibly deformable such that when the at least one first attachment member is inserted into said the second attachment member, the first attachment member can be firmly attached in a frictionally locking manner. As a result, no further attachment and/or guide elements are required. The attachment can be accomplished without any additional tools, in that the two components are simply pressed into one another. At the same time, the production of the escutcheon members can be accomplished without the installation of a complex anchoring mechanism. As such, it is possible for the second attachment member to include, for example, a short threaded shaft that is attached to the back of the escutcheon members. The accommodation element can then be screwed onto the threaded shaft. For this it is practical for the accommodation element to consist of a flexible material such as polyoxymethylene (“POM”). It is, of course, also possible to use another correspondingly flexible resiliently deformable synthetic material.

When the first attachment member is inserted into a second attachment member made of such a material, the cross-section of the accommodating element is deformed such that it accommodates or corresponds to the shape of the attachment element. Friction is established between the outer surface of the first attachment member and the inner surface of the accommodating element. Consequently, the friction is greatest at the point where the first attachment member deforms the accommodating element from its original shape. The first attachment member is firmly held by this friction in the accommodating element.

In order to install the escutcheon assembly on the door, it is therefore only necessary to position the escutcheon members on both sides of the door, to press first and second attachment members toward each other through a hole previously made in the door, and thereby to push the first attachment member into the accommodating member. Once the accommodating element has been deformed by the first attachment member, the escutcheon members are held together. The escutcheon members are then pressed against each other to overcome the existing friction until they are firmly located against the opposite sides of the door. It may be seen that there is a further, particular, advantage of the invention in that the insertion of the first attachment member into the accommodating element is achieved smoothly, i.e. in a continuous manner. In this manner, the escutcheon assembly of the invention may be installed on doors of different thicknesses.

In a preferred embodiment of the invention it is intended that the attachment system comprise two first attachment members and two second attachment members. This has the advantage that the escutcheon members cannot be rotated with respect to each other, because they are each attached at two points to each another. It is particularly convenient if each accommodating element features a first and a second attachment element, whereby the first and second attachment members are arranged in a radially or axially symmetric manner to the middle of the respective escutcheon member. This has the advantage that all escutcheon members are identical, thus reducing the number of different components. If two such identical escutcheon members are used for an escutcheon assembly, they may be placed on opposites sides of the door such that their backs are facing each other. If on each back surface there is disposed a first attachment member and a second attachment member in the symmetrical manner described above, then with the placement of the escutcheon members on opposite sides of the door the first attachment member of the one escutcheon member is opposite the second attachment member of the other escutcheon member, and the second attachment member of the first escutcheon member is opposite the first attachment member of the other escutcheon member.

It may be seen that a further advantage of the invention is that the attachment members are arranged orthogonally or perpendicular to the back surface of the escutcheon members. This makes the attachment of the escutcheon members to one another easier.

A further major advantage of the invention is that the escutcheon assembly features a centering system. This ensures that the escutcheon members may be installed on the door in the correct position.

Furthermore, this ensures that the installed escutcheon members can neither be shifted sideways nor rotated. For this it is practical if the centering system comprises at least one securing element which is disposed on the back of one of the two escutcheon members. Preferably, the securing element fits into a recess in the door when the escutcheon assembly has been installed. In this manner, it is, for example, conceivable that two holes are provided in the door and/or in the lock assembly located in the door which holes are of a size and orientation to each another such that the attachment members on the back of the escutcheon members may be inserted through the two holes. If a respective escutcheon member is applied to the door in this manner, it cannot be shifted to the side or rotated, and it is held against the door by the escutcheon member on the other side. It may thus be seen that it is particularly practical if the securing element is formed by a first and/or second attachment member.

It may therefore be seen that the particular advantages of the escutcheon assembly of the present invention consist in that it can be installed without tools, that the attachment members are not visible when they are installed, that they may be installed independently of the door thickness, and that a durably firm and correct position is ensured.

### DESCRIPTION OF THE DRAWINGS

Further characteristics, details, and advantages of the invention may be derived from the claims as well as from the following description of embodiments based on the illustrations, in which:

FIG. 1 is an exploded isometric view from the side and above of an escutcheon assembly;

FIG. 2 is a detailed enlargement of the region Z from the escutcheon assembly illustrated in FIG. 1; and

FIG. 3 is an exploded isometric view from the side and above of an escutcheon assembly in its installed state.

### DETAILED DESCRIPTION OF THE EXEMPLARY EMBODIMENT

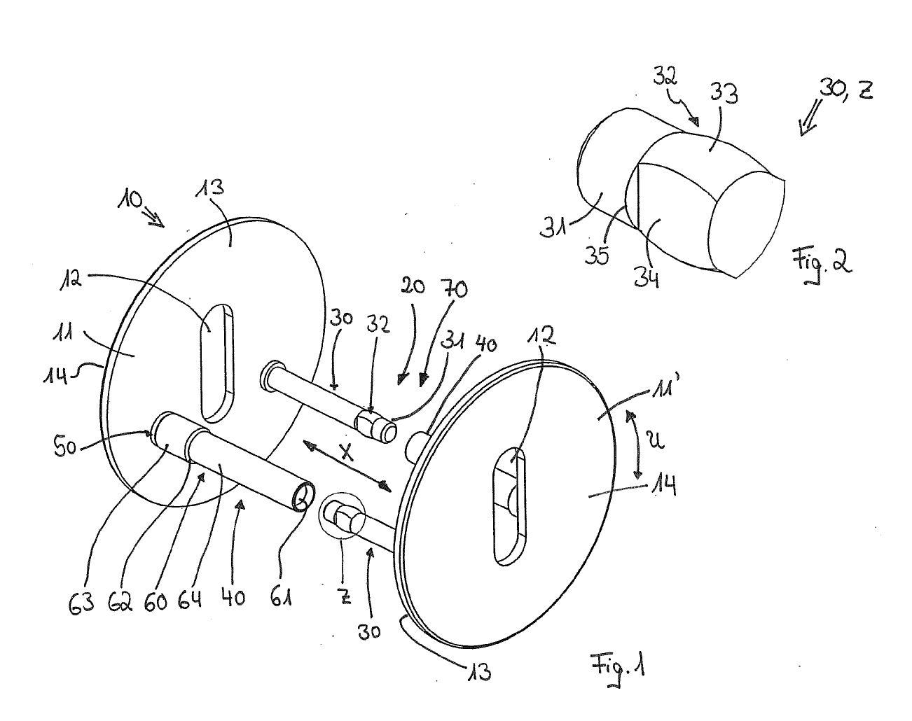

The escutcheon assembly generally indicated by the reference numeral 10 in FIG. 1 is constructed for a door to a room (not shown) which will typically have a mortise lock (also not shown), which is inserted from the front in the known manner. The escutcheon assembly 10 is comprised of two escutcheon members 11, 11′ which will be located on the respective sides of a door and are attached to each other by means of an attachment system 20. The attachment system comprises, in a preferred embodiment, two first attachment members 30 and two second attachment members 40.

As FIG. 1 also shows, each escutcheon member 11, 11′ has a first attachment member 30 and a second attachment members 40 on its back 13. These are disposed such that the first attachment member 30 of one of the escutcheon members 11, 11′ and the second attachment member 40 of the other of the escutcheon members 11, 11′ are opposite one another when the backs 13 of the escutcheon members 11, 11′ face each other. One sees that the front surfaces 14 of the escutcheon members 11, 11′ have an entirely smooth surface aside from an optional opening 12 for a lock assembly.

The first attachment member 30 consists respectively of a shaft, which extends orthogonally or in the axial direction X from the back 13 of the escutcheon members 11, 11′.

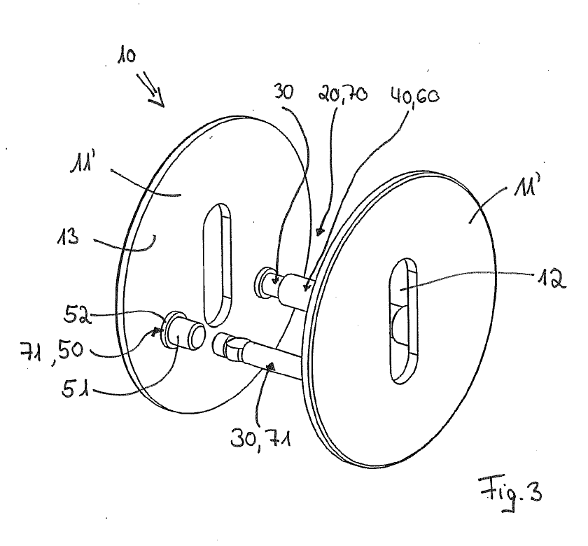

In order to attach the attachment member 30 to an accommodating element 60 included in the second attachment member 40, the attachment member 30 is provided with an enlarged bulge 32 at its front or distal end 31 (best shown in FIG. 2, which is a detail enlargement Z from FIG. 1). This is basically an enlargement of the cross-section of the first attachment member 30, in which, for example, a limited portion of the bulge 32 is crimped or pressed flat.

The bulge 32 therefore comprises two opposing outwardly swollen bulges 33 which extend respectively beyond the diameter of the preferably circular or cylindrical circumference 35 of the first attachment member 30, as well as two recesses 34 having flat surfaces which are within the diameter of the circumference 35 of the first attachment member 30. The first attachment member 30 retains its cylindrical cross-section over the course of the rest of its length, in particular at the front or proximal end 31 and between the bulge 32 and the portion that is attached to the respective escutcheon members 11, 11′.

It is important that the opposing bulges 33 are such that at their respective apexes they are larger than the preferred circular inner diameter of an opening 61 in the distal end of the second attachment member 40, into which the distal end of the first attachment member 30 will be inserted for installation.

The second attachment member 40 comprises the accommodating element 60 which is mounted at its proximal end onto an attachment pin 50 on the rear 13 of the escutcheon members 11, 11′ and which likewise extends orthogonally or in the axial direction X away from the back 13.

The accommodating element 60 comprises a cylindrical sleeve made of a resiliently or reversibly deformable substance, having an opening 61 at its distal end. The distal end of the first attachment member 30 can be inserted into the opening 61 of the accommodating element 60 during the installation of the escutcheon assembly 10.

The accommodating element 60 may be screwed onto the attachment pin 50. To facilitate this installation, the attachment pin 50 may comprise a base 52 which is attached to the back 13 of the respective escutcheon members 11, 11′ and a short threaded pin 51. The attachment pin 50 may be made of the same material as the escutcheon member 11 or 11′. It may alternatively be attached to the back 13 by glue, a weld, or brazing.

Of course it is also conceivable that the short pin 51 have a smooth or profiled surface, onto which the accommodating element 60 is simply pushed and then attached by means of crimping, welding, brazing, or another similar manner, and it may instead be produced from a different material than the material of the escutcheon members 11, 11′.

When the first attachment member 30 is inserted into the second attachment member 40, the previously circular cross-section of the accommodating element 60 is deformed to an oval cross-section at the point where the accommodating element 60 encompasses the bulge 32 of the first attachment member 30. Friction occurs thereby between the outer surface of the bulge 33 and the inner surface of the accommodating element 60, thereby anchoring the first attachment member 30 in the second attachment member 40. The friction occurs as a result of the bulge 32 pressing against the synthetic inner surface of the accommodating element 60 and the synthetic material striving to reassume its original shape, whereby it presses against the bulge 32. One sees the advantage here of the recesses 34. This results in the synthetic material of the accommodating element 60 being merely deformed, and not stretched. The bulge is sized for this purpose such that its circumference has a different shape than the circumference 35 of the rest of the first attachment member 30. The size of the circumference of the bulge 32, however, may be the same or even slightly smaller than the size of the circumference 35 of the rest of the first attachment member 30.

One can see that in this manner the installment of the escutcheon assembly 10 can be made quickly and easily. In particular, no tools are necessary for the installation. Instead, the escutcheon members 11, 11′ are simply placed on each side of the door (not shown) and inserted through a hole (also not shown) in the door toward each other, whereby the respective first attachment member 30 engages in the second attachment member 40. Once the bulge 32 has entered the accommodation element 60, the escutcheon members 11, 11′ firmly hold each other in place. They must then only be pressed against each other until they lie firmly against the outer surfaces of the door. This entire installment is thereby reduced to two steps which can be quickly and easily carried out, in that the shafts are fed into the corresponding holes and are subsequently pressed together. Neither additional attachment elements nor any tools are necessary for the installation, which not only has practical applications regarding the handling of the escutcheon assembly 10, but also significantly reduces the production and installation costs of the escutcheon assembly 10.

One sees that there is a further advantage if the first attachment member 30 can be inserted smoothly and continuously into the second attachment member 40. The installation of the escutcheon assembly 10 can therefore be carried out on doors of different thicknesses without it being necessary to provide special components for each door thickness.

In the embodiment shown in FIGS. 1 and 3, the attachment system 20 also forms a centering system 70. The symmetrical attachment members 30, 40 disposed on the backs 13 of the respective escutcheon members 11, 11′ may be fed through corresponding lock assembly holes or holes in the door for the installation. In this manner both a radial movement, i.e. shifting of the escutcheon members 11, 11′, as well as a rotation in the circular direction U, are prevented. A rotation of the escutcheon members 11, 11′ is also impossible with this. One sees that the attachment members 30, 40 in the present embodiment also form the securing element 71 of the centering system 70.

A simplified principle of the centering system 70 can be seen in FIG. 3. For this, to illustrate more clearly the structure of the second attachment member 40, the accommodation element 60 is omitted from the illustration on one side. As in the previous embodiment, both escutcheon members 11, 11′ have a first attachment member 30 and an attachment pin 50 for a second attachment member 40. The accommodating element 60 placed on the one (hidden) attachment pin 50 forms the attachment for the escutcheon assembly 10 together with the opposing first attachment member 30 on the other escutcheon members 11.

Both the attachment pin 50 on which there is no accommodation element 60 as well as the attachment member 30 which is opposite this attachment pin 50 in the illustrated embodiment may be seen as examples of embodiments for securing elements 71 of the centering system 70. With both it is intended that they can each engage in a hole or opening provided in the door or lock assembly, thereby preventing rotation of the escutcheon members 11, 11′ about the axes of which the attachment members 30, 40 which are pressed together. One can see clearly that a simple shaft or pin could also be used as a securing element 71.

To further ensure a secure placement of the securing element 71 in the corresponding hole or opening in the door, or respectively, the lock assembly, the securing element 71 may be formed to correspond to the shape of the opening.

One sees in FIG. 1 that the accommodation element 60 has a cylindrical collar 63 at its lower or proximal end which transitions at its shoulder 62 into the cylindrical sleeve 64 of the accommodating element 60. Furthermore, the collar 63 can correspond in both its shape and its size to the inner surface of the opening. It is also conceivable that the collar 63 could be provided with grooves which compensate for tolerance.

The invention is not limited to the embodiments described above, but it may be modified in a number of different manners. As such, for example, a number of different methods may be used to attach the accommodating element 60 to the attachment pin 50, such as attaching it directly to the back 13 of the escutcheon members 11, 11′. The shape and size of the securing element 71 may also be varied.

Instead of an opening 12 for a keyhole, an axially fixed, rotatable doorknob may be provided on the escutcheon members 11, 11′, in order to make the escutcheon assembly 10 appropriate for a bathroom door, for example.

With an escutcheon assembly 10 for a door wherein the escutcheon assembly 10 has two escutcheon members 11, 11′ which are placed on opposite sides of the door and are attached with at least one attachment system 20, wherein the attachment system 10 comprises at least one first attachment member 30 and at least one second attachment member 40, it is particularly advantageous if at least one first attachment member 30 is provided on the back 13 of one of the escutcheon members 11, 11′ and the at least one second attachment member 40 is provided on the back 13 of the other of the escutcheon members 11, 11′, and if the at least one first attachment member 30 can be inserted into the at least one second attachment member 40, wherein the at least one second attachment member 40 features an accommodating element 60, in which the at least one first attachment member 30 can be inserted, and wherein the accommodating element 60 is reversibly deformable through the insertion of the at least one first attachment member 30 such that the at least one first attachment member 30 can be frictionally firmly attached to the accommodating element 60.

It is also convenient when the insertion of the first attachment member 30 into the accommodating element 60 can be achieved in a continuous manner. By this it is meant that the escutcheon assembly 10 can be used with practically any door, since different door thicknesses are automatically compensated for by this design. The escutcheon members 11, 11′ lie flat and axially secured on the outer surfaces of the door, which has a practical effect regarding stability. Furthermore, the overall visual effect of the door is enhanced.

Furthermore, it serves a purpose when the attachment system 20 includes two first attachment members 30 and when the attachment system includes two second attachment members 40. Preferably, the first and second attachment members 30, 40 are arranged and configured to be radially or axially symmetrical to the center of the respective escutcheon members 11, 11′. For this it is advantageous if the attachment members 30, 40 are disposed in an orthogonal orientation or axial direction X on the back 13 of the escutcheon members 11, 11′.

One may furthermore appreciate that a particular advantage of the invention is that the escutcheon assembly 10 features a centering system 70. For this it is convenient if the centering system 70 comprises at least one securing element 71 located on the back 13 of one of the escutcheon members 11, 11′.

It serves this purpose when the securing element 71 engages an opening in the door when the escutcheon assembly 10 has been installed.

Furthermore, the securing element 71 may be formed by a first and/or second attachment member(s) 30, 40.

All characteristics and advantages from the claims, description and illustrations, including constructive details, spatial configurations, and method steps may be regarded as fundamental aspects of the invention both in and of themselves as well as in various combinations. Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

### LIST OF REFERENCE NUMBERS

U Circumferential direction
X Axial direction
Z Detail
10 Escutcheon assembly
11 Escutcheon member
11′ Escutcheon member
12 Opening
13 Back
14 Front
20 Attachment system
30 First attachment member
31 Front end
32 Shaft bulge
33 Bulge
34 Recess
35 Circumference
40 Second attachment member
50 Attachment pin
51 Short pin
52 Base
60 Accommodating element
61 Opening
62 Shoulder
63 Collar
64 Sleeve
70 Centering system
71 Securing element

What is claimed is:

1. An escutcheon assembly for a door, comprising:
two escutcheon members for application to opposite sides of the door; and
at least one attachment system for attaching the two escutcheon members together, the attachment system comprising:
at least one first attachment member located on a back side of one of the escutcheon members; and
at least one second attachment member located on a back side of the other escutcheon member;
wherein the at least one first attachment member can be firmly anchored in the at least one second attachment member; and
whereby the at least one second attachment member features an accommodating element into which the at least one first attachment member can be inserted; and
wherein the accommodating element is resiliently deformable such that through the insertion of the at least one first attachment member into the accommodating element in the second attachment member, the at least one first attachment member can be firmly anchored in the accommodating element.

2. The escutcheon assembly of claim 1, wherein the accommodating element is configured so that the insertion of the first attachment member into the accommodating element can occur in a continuous manner.

3. The escutcheon assembly of claim 1, wherein the attachment system comprises two first attachment members and two second attachment members.

4. The escutcheon assembly of the claim 3, wherein the first and second attachment members are configured to be radially or axially symmetrical to the center of the respective escutcheon members.

5. The escutcheon assembly of claim 1, wherein the first and second attachment members extend orthogonally from the backs of the escutcheon members.

6. The escutcheon assembly of claim 1, wherein the escutcheon assembly comprises a centering system.

7. The escutcheon assembly of claim 6, wherein the centering system comprises at least one securing element located on the back of one of the escutcheon members.

8. The escutcheon assembly of claim 7, wherein the securing element is configured to engage an opening in the door when the escutcheon assembly is installed.

9. The escutcheon assembly of claim 7, wherein the securing element comprises at least one of the first and second attachment members.

10. An escutcheon assembly for a door, comprising:
first and second escutcheon members for respective application to opposite sides of the door; and
a first attachment member extending from a back side of each of the first and second escutcheon members; and
a second attachment member extending from the back side of each of the first and second escutcheon members;
wherein the first attachment member located on the back side of the first escutcheon member is configured to be inserted into and firmly anchored within an accommodating element in the second attachment member located on the back side of the second escutcheon member; and
wherein the first attachment member located on the back side of the second escutcheon member is configured to be inserted into and firmly anchored within an accommodating element in the second attachment member located on the back side of the first escutcheon member.

11. The escutcheon assembly of claim 10, wherein the accommodating elements in the second attachment members are configured to allow the first attachment members to be inserted into and firmly anchored within the accommodating elements such that the first and second escutcheon members may be located at a variable distance apart to thereby accommodate doors of varying thicknesses.

12. The escutcheon assembly of claim 10, wherein the first and second attachment members are configured to be radially or axially symmetrical to the center of the respective escutcheon members.

13. The escutcheon assembly of claim 10, wherein the first and second attachment members extend orthogonally from the backs of the escutcheon members.

14. The escutcheon assembly of claim 10, wherein at least one of the first and second attachment members is configured to engage either an opening in the door or an opening in a lock arrangement located the door to maintain each of the first and second escutcheon members in a desired position on the door.

15. The escutcheon assembly of claim 10, wherein the first attachment member comprises:
a shaft extending orthogonally from the back of the attachment member to which it is attached; and
an enlarged element located at an end of the shaft distal from the back of the attachment member to which the shaft is attached.

16. The escutcheon assembly of claim 15, wherein the enlarged element comprises:
an enlarged bulge having portions that extend outwardly beyond the outer diameter of the shaft; and
recesses located in the enlarged element intermediate the outwardly extending portions thereof.

17. The escutcheon assembly of claim 10, wherein the second attachment member comprises:
an attachment element located on and extending from the back of the attachment member to which it is attached; and
wherein the accommodating element of the second attachment member comprises:
a cylindrical sleeve made of a resiliently or reversibly deformable substance, the cylindrical sleeve being mounted onto the attachment element and extending therefrom, an end of the first attachment element located distal from the back of the attachment member from which it extends being insertable into the cylindrical sleeve during the installation of the escutcheon assembly.

18. The escutcheon assembly of claim 17, wherein the cylindrical sleeve is made of a flexible synthetic material such as polyoxymethylene (“POM”).

19. The escutcheon assembly of claim 10, wherein a first escutcheon assembly comprises the first escutcheon member and the first and attachment member extending from the back side thereof, and wherein a second escutcheon assembly comprises the second escutcheon member and the first and attachment member extending from the back side thereof, wherein the first and second escutcheon assemblies are identical.

20. A method of installing an escutcheon assembly into a door having at least one opening therein, comprising:
positioning a first escutcheon member comprising first and second attachment members extending from a back side of the first escutcheon member on one side of the door with the first and second attachment members extending from the back side of the first escutcheon member extending into the hole in the door;
positioning a second escutcheon member comprising first and second attachment members extending from a back side of the second escutcheon member on the opposite side of the door with the first and second attachment members extending from the back side of the second escutcheon member extending into the hole in the door;
aligning the first attachment member extending from the back side of the first escutcheon member with the second attachment member extending from the back side of the second escutcheon member;
aligning the second attachment member extending from the back side of the first escutcheon member with the first attachment member extending from the back side of the second escutcheon member;
pushing the first attachment member extending from the back side of the first escutcheon member into an accommodating element in the second attachment member located on the back side of the second escutcheon member;
pushing the first attachment member extending from the back side of the second escutcheon member into an accommodating element in the second attachment member located on the back side of the first escutcheon member; and
pressing the first and second escutcheon members toward each other until they are respectively firmly located against the opposite sides of the door.
